(19) United States
(12) Patent Application Publication
(10) Pub. No.: US 2008/0288763 A1
(43) Pub. Date: Nov. 20, 2008

(54) Method For Controlling the Operation of a Display Screen In A Computing Device

(75) Inventor: Matthias Reik, Ronneby (SE)

Correspondence Address: FOX ROTHSCHILD LLP, P O BOX 592, 112 NASSAU STREET, PRINCETON, NJ, 08542-0592, US

(73) Assignee: UIQ TECHNOLOGY AB, Ronneby (SE)

(21) Appl. No.: 11/571,028

(22) PCT Filed: Jul. 1, 2005
(86) PCT No.: PCT/GB2005/002598

§ 371 Date: Dec. 20, 2006

(30) Foreign Application Priority Data
Jul. 2, 2004 (GB) 0414841.7

(51) Int. Cl. G06F 9/445

(52) U.S. Cl. 713/2

(57) ABSTRACT

In a computing device such as a mobile phone which includes a splash-screen displayed while the operating system is booting up, the portion of the operating system which is responsible for the display after booting up is provided with all the information about the state of the splashscreen, so that a smooth transition is provided between the splashscreen and the initial screen under the control of the operating system when control of the screen is passed from the boot-up process to the operating system.

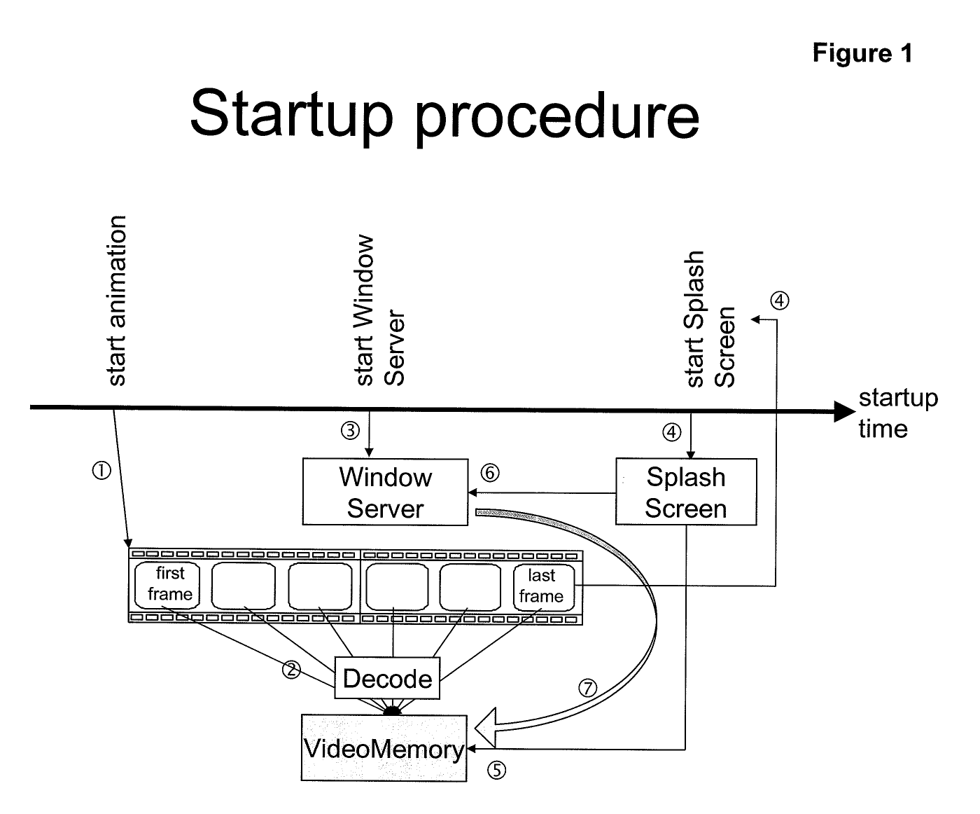

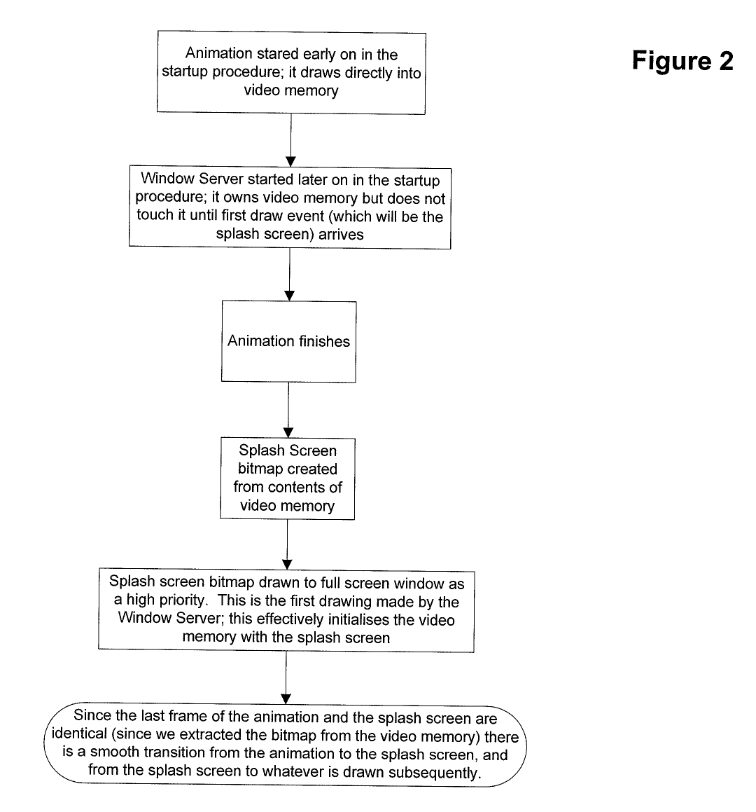

The present invention relates to a method for controlling the operation of a display screen in a computing device, and in particular to a method for controlling the operation of the display screen in a manner to provide a smoother and improved user experience when switching on a computing device.

The term computing device as used herein is to be expansively construed to cover any form of electrical computing device and includes, data recording devices, computers of any type or form, including hand held and personal computers, and communication devices of any form factor, including mobile phones, smart phones, communicators which combine communications, image recording and/or playback, and computing functionality within a single device, and other forms of wireless and wired information devices.

Computing devices in general require a period of time to boot up; from the point of view of a user this delay (from switching on the device to the point at which it becomes fully functional an operational) is generally regarded as rather irksome. Where a device is only switched on once for each period of relatively prolonged use, such as the typical use of a desktop PC in an office environment, the boot up delay is generally regarded as only a minor irritant. However, for battery operated computing devices, which users typically switch on and off several times in a typical day of use in order to conserve power when the device is not in actual use, this delay can be regarded as a serious problem. Furthermore, it can often be the case that a user switches the device on an as needs basis with the expectation that because they require to use the device immediately, it will be fully operational upon command at switch on. It is widely recognised that modern digital computer based mobile devices all appear to give rise to increased concerns in this area of operation because they are being provided with ever increasing functionality with the attendant increase in boot up times.

Analogue radios, chemical film based cameras, cassette recorders and landline telephones were all ready to use instantly; but their computer-based ‘equivalent’ successors, such as digital radios, digital cameras, MP3 music players, and mobile telephones all exhibit the sort of boot time delays which consumers thought had become defunct with the availability of solid state electrical devices.

In order to mitigate the irritation to users, many manufacturers of such digital devices generally display some sort of start up graphic on the screen of the devices, preferably an animated one with some form of progress indicator, to reassure users that the device is actually operational, provide the user with something to look at during the boot time delay, and also possibly to conceal the less than comforting display of various boot-up and initialisation messages that might otherwise be displayed and reinforce the feeling of the user that he/she is not really in control of the device. In essence, the start up display is provided to distract the user during this boot up delay. This boot-up graphic display is widely known in this art as a splash-screen.

Most mobile battery operated computing devices include an operating system which controls the hardware on the device, including the display that appears on the screen. When the device is first powered on and the splash-screen appears, the operating system (OS) has not yet fully initialised and is not yet in full control of the device hardware. Many complex tasks need to be completed before the OS is precisely in control of all device functions, such as the loading of files from non executable to executable memory, and the number and complexity of these tasks is principally why there is a boot time delay. The splash-screen graphic displayed during this boot time is placed directly on the screen as a bitmap image by the boot-up routines embedded in the device. Therefore, the splash screen is not displayed under the direct control of the device operating system.

Once the OS has powered up, it can as one of its tasks take control of the display on the screen. But, because the splash-screen was placed on the display prior to the OS booting, the OS has no knowledge of what is being displayed on the screen. Consequently, the OS subsequently taking control of the screen display is typically marked by an abrupt flicker or judder or complete change in the screen display which occurs when the OS replaces the graphic it knows nothing about with its own display image.

This abrupt display change is usually unsightly and provides a poor user experience. However, because the OS cannot possibly command the splash-screen for display when it has not yet been fully booted, there is no way to prevent this visual effect.

It is therefore an object of the present invention to provide an improved form of start up display animation in a computing device so as to display to a user a completely smooth and imperceptible transition from a power-up splash-screen to a display that is fully under the control of the OS.

According to a first aspect of the present invention there is provided a method of operating a computing device in which software for loading an operating system for the device places a still and/or animated splash-screen on a display of the device while said operating system is loading and preparing to run; the method comprising passing information regarding the state of the display to that portion of the operating system for controlling display, and enabling a portion of the operating system responsible for display to treat the splashscreen as if it had placed it on the screen itself and provide a controlled transition from the splash-screen to a screen display under the control of the operating system.

According to a second aspect of the present invention there is provided a computing device arranged to operate in accordance with a method of the first aspect.

According to a third aspect of the present invention there is provided an operating system for a computing device for causing the computing device to operate in accordance with a method of the first aspect.

An embodiment of the present invention will now be described, by way of further example only.

The perception behind this invention is that once a computing device OS has fully booted up and is in control of the device display screen, it is capable of determining what the video hardware in the device is doing and what the contents of the video buffers on the device might be; an immediate write to the screen is therefore not necessary.

Once the OS knows what is being displayed on the device display, it can initiate a seamless and smooth transition of screen ownership (from the boot processes to the operating system) which is imperceptible to the user of the device.

A number of variations on this basic method are possible. These include:
1) Where the software entity controlling the boot process is responsible for both the splash-screen and also the instantiation and initialisation of that component of the OS which is subsequently going to be responsible for the screen (a video driver or window server or other similar module, depending on the operating system in use) the entity can ensure that any screen bitmaps or other information under its control are passed to the screen control component of the OS upon its initialisation in such a way that it is indistinguishable from its native display states.
2) If the splash-screen is not under the control of the boot process, part of the boot process may be arranged for the state of the screen to be read and any bitmaps or other information so generated can then be passed to that component of the OS which is going to be responsible subsequently for the screen (a video driver or window server or other similar module, depending on the operating system in use) before it is fully instantiated.
3) Alternatively, the boot process can be left unmodified; in this case, when one of the modules of the OS gains control of the screen, that module reads the video hardware and its memory buffers to find out what splash-screen (or start-up animation) is in progress at that time; and once it has read that data, it converts the data into its own format and goes on to take control of the display with full knowledge of the current state of the display. Note that in this embodiment of the invention, nothing in the OS seeks to use the display module before it has completed this read and convert task.

Those skilled in the art of programming computing devices will readily recognise the use to which the technique of enabling smooth transitions by reading before writing can be put. Any one of these techniques will avoid any irritating flicker or judder on the transfer of control; and when the OS wishes to replace the splash-screen with its own display, it can do so in a controlled and smooth manner, providing a more enchanting experience for the user.

Those skilled in art will also recognise that variations of this same mechanism can be used in other circumstances where control of a part of the device providing any type of sensory input to the user passes from the control of one item of software to another. Therefore, audio as well as video drivers are also able to benefit from the principles of the present invention.

By enabling a smooth transition from a start up splash-screen to a display under the control of the operating system, this invention provides users with a better and more enchanting user experience at one of the times most critical for their acceptance of the device and their tolerance of some of its main drawbacks.

In summary, the present invention provides an improved method of operating a computing device such as a mobile phone which includes a splash-screen displayed while the operating system is booting up. Instead of a sudden change in the visual display when control of the screen is passed from the boot-up process to the operating system, this invention enables a smooth transition from the splash-screen to the initial display under the control of the OS. This is achieved by ensuring that the portion of the OS which is responsible for the video display is provided with all the information about the current state of that display, so its initial screen can be displayed in an orderly and non-disruptive manner form that of the splash screen display.

Although the present invention has been described with reference to particular embodiments, it will be appreciated that modifications may be effected whilst remaining within the scope of the present invention as defined by the appended claims.

1. A method of operating a computing device in which software for loading an operating system for the device places a still and/or animated splash-screen on a display of the device while said operating system is loading and preparing to run; the method comprising passing information regarding the state of the display to that portion of the operating system for controlling display, and enabling a portion of the operating system responsible for display to treat the splashscreen as if it had placed it on the screen itself and provide a controlled transition from the splash-screen to a screen display under the control of the operating system.

2. A method according to claim 1 wherein the software responsible for loading the operating system possesses information about the state of the display by virtue of its control of the splashscreen.

3. A method according to claim 1 wherein the software responsible for loading the operating system obtains information about the state of the display by directly reading the device hardware responsible for display of the splashscreen.

4. A method according to claim 1 wherein the state of the display is read by the said portion of the operating system.

5. A method according to claim 1 applied to boot-up music or audio and a sound system either instead of or in additional to a still and/or animated splash-screen.

6. A method according to claim 1 applied to multimedia presentations and multimedia systems.

7. A computing device arranged to operate in accordance with a method as claimed in claim 1.

8. An operating system for a computing device for causing the device to operate in accordance with a method as claimed in claim 1.
